(19) United States
(12) Patent Application Publication
(10) Pub. No.: US 2020/0140301 A1
(43) Pub. Date: May 7, 2020

(54) Method for determining optimal preservation temperature of biofilm in wastewater treatment

(71) Applicant: Jiangnan University, Wuxi (CN)

(72) Inventors: Shuo WANG, Wuxi (CN); Yin ZHU, Wuxi (CN); Ji LI, Wuxi (CN); Yan WANG, Wuxi (CN); Kaikai ZHENG, Wuxi (CN)

(21) Appl. No.: 16/720,243

(22) Filed: Dec. 19, 2019

Related U.S. Application Data
(63) Continuation of application No. PCT/CN2018/114552, filed on Nov. 8, 2018.

(30) Foreign Application Priority Data
Aug. 15, 2018 (CN) 2018109254213
Sep. 12, 2018 (CN) 2018110613927

(51) Int. Cl. C02F 3/10; B01D 71/56; G01N 15/14

(52) U.S. Cl. CPC C02F 3/102; B01D 71/56; C02F 2209/02; C02F 2209/16; G01N 15/1404

(57) ABSTRACT

The present disclosure discloses a method for determining optimal preservation temperature of biofilm in wastewater treatment, and belongs to the technical field of environmental engineering. The method for determining the optimum preservation temperature of the wastewater treatment biofilm constructed by the present disclosure comprises measuring the cell activity state of the biofilm by flow cytometry, and taking the preservation temperature closest to the cell activity state before preservation as the optimum preservation temperature. The method of the present disclosure can determine the optimum preservation temperature within a few hours and performs correlation analysis on the characteristic indexes of the biofilm activity recovery process to verify the reliability of the data. By using the method of the present disclosure, the step of recovering the activity of the biofilm process can be omitted, the pollutants can be discharged under the standard, and at the same time, the starting time of engineering application of the biofilm process can be effectively shortened, the long-term stable operation of the biofilm process is maintained, and the method has high industrial feasibility.

### TECHNICAL FIELD

The present disclosure relates to a method for determining optimal preservation temperature of biofilm in wastewater treatment, and belongs to the technical field of environmental engineering.

### BACKGROUND

The low content of organic pollutants in the inflow water of the wastewater treatment plant is always a technical difficulty for restricting the standard emission of total nitrogen, and simultaneously, along with the improvement of the emission standard of wastewater treatment, a large amount of soil is occupied by reconstruction and extension projects, a large amount of organic carbon source substances and phosphorus removal agents are added into a water body, so that the investment construction and operation cost are remarkably increased, the traditional activated sludge process cannot meet the emission requirement of pollutants, and thus the energy saving and consumption reducing effects of the wastewater treatment plant are seriously influenced. Therefore, wastewater denitrification technologies based on land-saving objectives and low carbon source utilization are receiving increasing attention. The effective wastewater treatment process in wastewater treatment comprises aerobic granular sludge, nitrifying-denitrifying biofilm process, wherein the aerobic granular sludge process has good settling performance, low operation cost, high biomass and treatment efficiency and thus has great development potential; the nitrifying-denitrifying biofilm process can realize synchronous nitrification and denitrification, and has important significance for removing ammonia nitrogen and total nitrogen in wastewater.

However, in the engineering example, the film forming period of the nitrifying-denitrifying biofilm is about 30-40 d, the culture period of the aerobic granular sludge is as long as 70-120 d, and the culture conditions are relatively harsh. If the aerobic granular sludge and the nitrifying-denitrifying biofilm can be cultured, matured and stored, the wastewater treatment plant with low carbon source in inflow water and short land resources can be effectively helped to start running in a short time, and pollutants can be discharged under the standard. The temperature is an important parameter influencing the activity of the biofilm, and the temperature which is most suitable for storing the biofilm such as aerobic granular sludge and nitrifying-denitrifying biofilm is determined, so that the activity recovery process is simplified, the starting time of engineering application is shortened, and the energy saving and consumption reducing effects are realized. However, in the existing method, the optimum preservation temperature needs to be determined by re-inoculating the aerobic granular sludge and the nitrifying-denitrifying biofilm into the bioreactor, and the time for determining the activity recovery effect of the aerobic granular sludge and the nitrifying-denitrifying biofilm is about 8-35 d, and thus the long time consumption becomes important for restricting the engineering application of the method.

### SUMMARY

In order to simplify the activity recovery process of the biofilm such as aerobic granular sludge and nitrifying-denitrifying biofilm, allow the pollutant indexes of the wastewater treatment plant to reach the standard for discharge in a short time and achieve the land saving, energy saving and consumption reducing effects at the same time, the present disclosure characterizes cell activity states in the biofilms stored under different temperature conditions based on the flow cytometry, verifies the characterization result of the flow cytometry according to the cell activity states after recovering the activity of the biofilm and the removal effect of pollutants, and finally establishes a method for determining the optimum preservation temperature of the biofilm based on the flow cytometry, and provides technical support for high-standard pollutant discharge and energy saving and consumption reducing operation of the wastewater treatment plant.

A first object of the present disclosure is to provide a method for determining an optimum preservation temperature of a wastewater treatment biofilm, which comprises measuring the cell activity state of the wastewater treatment biofilm based on flow cytometry, comparing the measured results of the cell activity states of the biofilm stored at different temperatures with those of the biofilm before preservation, and taking the preservation temperature closest to the cell activity state of the biofilm before preservation as the optimum preservation temperature.

In one embodiment of the present disclosure, the measurement of the cell activity state of the biofilm comprises the measurement of the content of living cells, early apoptotic cells, late apoptotic cells and dead cells.

In one embodiment of the present disclosure, the biofilm comprises aerobic granular sludge and a nitrifying-denitrifying biofilm.

In one embodiment of the present disclosure, the step of determining the optimum temperature in the flow cytometry comprises:

(1) preparing a biofilm test sample solution: diluting a biofilm sample with a buffer, shaking evenly, filtering, centrifuging, leaving the supernatant, purging the cells with a pre-cooled phosphate buffer, repeating centrifugation and wash twice, then taking the supernatant as a sample, and mixing well with an appropriate amount of 10× Annexin V Binding Buffer;

(2) placing in a flow cytometer for measuring the cell activity state of each sample solution.

In one embodiment of the present disclosure, the phosphate buffer is used as a buffer for dilution.

In one embodiment of the present disclosure, the phosphate buffer comprises sodium dihydrogen phosphate and disodium hydrogen phosphate.

In one embodiment of the present disclosure, when the biofilm is aerobic granular sludge, the preparation of the test sample solution is obtained by diluting aerobic granular sludge with a buffer of pH 7.0-8.0.

In one embodiment of the present disclosure, when the biofilm is a nitrifying-denitrifying biofilm, the preparation of the test sample solution is obtained by diluting the nitrifying-denitrifying biofilm with a buffer of pH 6.6-7.0.

In one embodiment of the present disclosure, the dilution volume ratio of the buffer to the biofilm is 8-10:1.

In one embodiment of the present disclosure, when the biofilm is aerobic granular sludge, a nylon membrane having a pore size of 5-15 μm is used for filtration.

In one embodiment of the present disclosure, when the biofilm is a nitrifying-denitrifying biofilm, a nylon membrane having a pore size of 6-8 μm is used for filtration.

In one embodiment of the present disclosure, the centrifugation speed is 5000-10000 rpm.

In one embodiment of the present disclosure, the mixed volume ratio of the sample supernatant to the 10× Annexin V Binding Buffer is 1:2-4.

In one embodiment of the present disclosure, the measurement of the cell activity state of each sample solution by the flow cytometer is carried out by adding 0.5 μl PI staining agent to the control FITC Annexin V group, adding 0.5 μl FITC Annexin V to the control PI group, adding 0.5 μl FITC Annexin V and 0.5 μl PI to the test group, mixing well, incubating in the dark at room temperature, and then testing on a flow cytometer.

In one embodiment of the present disclosure, the incubation time is 10-20 min.

A second object of the present disclosure is to provide a method for rapidly initiating the wastewater treatment biofilm engineering, which comprises preliminarily culturing and maturing the biofilm, placing in a preservation medium, storing at an optimum preservation temperature, and using for wastewater treatment after recovering the activity; the optimum temperature is determined by the above method.

In one embodiment of the present disclosure, the preservation medium of the aerobic granular sludge has a COD of 250 to 350 mg/L, NH₄⁺—N of 55-65 mg/L, and PO₄³⁻—P of 6-10 mg/L.

In an embodiment of the present disclosure, the activity recovery of the aerobic granular sludge comprises inoculating the aerobic granular sludge into a sequencing batch reactor (SBR) with an effective volume of 10.0 L, a water drainage ratio of 45-60%, a reaction period of 2.5-5 h, a static water inflow period of 1-1.5 h, an aeration reaction period of 1.5-2.5 h, a sludge settling period of 2-6 min, and a rapid drainage period of 2-6 min; controlling the air and nitrogen content and proportion to ensure the anaerobic state of the water inflow section and the aerobic state of the reaction section by a real-time control system; and controlling SRT to be 25 days.

In one embodiment of the present disclosure, the preservation medium of the nitrifying-denitrifying biofilm has a COD of 180-220 mg/L, NH₄⁺—N of 25-35 mg/L, NO₃⁻—N of 18-25 mg/L and PO₄³⁻—P of 6-10 mg/L.

In one embodiment of the present disclosure, the activity recovery of the nitrifying-denitrifying biofilm comprises inoculating a nitrifying-denitrifying biofilm into a bioreactor, based on an anoxic-oxic process, setting HRT as 10-15 h, the nitrification and denitrification filling ratio as 40%-60%, and the nitrifying liquid reflux ratio as 70%-85%.

A third object of the present disclosure is to apply the above method to wastewater treatment.

### Advantageous Effects of the Present Disclosure

The present disclosure characterizes the proportion of living cells, early apoptotic cells, late apoptotic cells and dead cells of various biofilms through flow cytometry, determines the optimum preservation temperature within a few hours, performs correlation analysis on the characteristic indexes of the biofilm activity recovery process, and establishes the method for determining the optimum preservation temperature of the biofilm based on the flow cytometry. By using the method, the step of recovering the biofilm activity can be omitted, the wastewater treatment plant which intends to adopt the biofilm process technology to discharge the pollutants (ammonia nitrogen, total nitrogen, total phosphorus) under the standard is effectively helped to realize the land saving, energy saving and consumption reducing operation, and simultaneously, the starting time of engineering application of the biofilm process can be effectively shortened, the long-term stable operation of the biofilm process is maintained, and the method has high industrial feasibility.

### BRIEF DESCRIPTION OF FIGURES

FIG. 1 shows the settling performance of aerobic granular sludge (sludge volume index SVI).

FIG. 2 shows changes in the extracellular polymer (PN/PS) of aerobic granular sludge.

FIG. 3 shows the removal rate of total nitrogen (TN) in aerobic granular sludge.

FIG. 4 shows the removal rate of total phosphorus (TP) in aerobic granular sludge.

FIG. 5 shows changes in the extracellular polymer PN/PS of nitrifying-denitrifying biofilm.

FIG. 6 shows the removal rate of ammonia nitrogen (AN) in nitrifying-denitrifying biofilm.

FIG. 7 shows the removal rate of total nitrogen (TN) in nitrifying-denitrifying biofilm.

### DETAILED DESCRIPTION

The wastewater of the wastewater treatment plant of the present disclosure includes domestic water in residential areas and a small part of industrial wastewater in the upstream, and the annual average of inflow water is COD of 236 mg/L, ammonia nitrogen of 30.1 mg/L, total nitrogen of 37.8 mg/L, and total phosphorus of 4.5 mg/L. The nitrate nitrogen content is less than 1.0 mg/L.

### Example 1: Determination of the Optimum Preservation Temperature of Aerobic Granular Sludge

Preservation Conditions of Aerobic Granular Sludge:

The preservation temperature of the aerobic granular sludge was set to −20° C., 4° C. and 20° C. The 900 mL of the aerobic granular sludge and wastewater mixture in the aerobic granular sludge pilot plant was taken out, divided into three equal portions and placed in 1000 mL serum bottles containing 500 mL of preservation medium, respectively. The components of preservation medium were as follows: NaAc of 4200 mg/L, NH₄Cl of 1100 mg/L, K₂HPO₄ of 370 mg/L, KH₂PO₄ of 140 mg/L, MgSO₄ of 440 mg/L, KCl of 170 mg/L, and trace element solution of 1 ml/L; the components of trace element liquid composition were as follows: FeCl₃.6H₂O of 1.5 g/L, H₃BO₃ of 0.15 g/L, CuSO₄.5H₂O of 0.03 g/L, KI of 0.03 g/L, MnCl₂.4H₂O of 0.12 g/L, Na₂MoO₄.2H₂O of 0.06 g/L, ZnSO₄.7H₂O of 0.12 g/L, and CoCl₂.6H₂O of 0.15 g/L. The preservation medium had a COD of 300 mg/L, NH₄⁺—N of 60 mg/L, and PO₄³⁻—P of 8 mg/L. Serum bottles (3 parallel samples at each preservation temperature) were placed at −20° C., 4° C. and 20° C., and stored statically in the dark for 3 months.

Cell State Characterization of Stored Aerobic Granular Sludge:

Cell State Test Conditions by Flow Cytometry were as Follows:

(1) A mixture of aerobic granular sludge stored in a 10 mL pilot system at each temperature for 3 months was taken, respectively, diluted to 100 mL with phosphate buffer of pH 7.2, and shaken for 2 min in a vortexer to break the sludge into flocs and ensure a uniform distribution;

(2) The crushed sample was filtered through a nylon membrane having a pore size of 10 μm, and 1.5 mL was placed in a 1.5 mL sharp-bottomed centrifuge tube;

(3) The sample was centrifuged at 8000 rpm for 5 min;

(4) The supernatant of the sample after centrifugation was pipetted with leaving about 0.1 mL of sample, the cells were purged with pre-cooled phosphate buffer, and the centrifugation and wash were repeated twice;

(5) The supernatant of the sample after centrifugation was pipetted with leaving about 0.1 mL of sample, and mixed well with 0.3 mL of 10× Annexin V Binding Buffer;

(6) 0.5 μL of PI staining agent was added to the control FITC Annexin V group, 0.5 μL of FITC Annexin V was added to the control PI group, 0.5 μL of FITC Annexin V and 0.5 μL of PI were added to the test group, which were mixed well and incubated for 15 min at room temperature in the dark, and then tested on a flow cytometer.

The cell state results of aerobic granular sludge were shown in Table 1. The living cell proportion of aerobic granular sludge in the pilot system was higher, indicating that the pilot system works well. The aerobic granular sludge stored at −20° C. had the lowest living cell content and the highest dead cell content, indicating that it was not suitable to store aerobic granular sludge at −20° C. The aerobic granular sludge stored at 4° C. had a proportion of late apoptotic cells and dead cells of about 25.2%, indicating that the 4° C. condition can be used for the preservation of aerobic granular sludge. However, when the preservation temperature was 20° C., the living cell proportion of aerobic granular sludge was as high as 68.5%, which was only 20.0% lower than that of the aerobic granular sludge in the pilot system, indicating that the preservation condition at 20° C. was more suitable for storing aerobic granular sludge, at the same time, since it was necessary to consume more energy to control and maintain the low temperature condition of 4° C., it was preliminarily determined that 20° C. was the optimum temperature for storing aerobic granular sludge.

TABLE 1
Cell activity states (%) of aerobic
granular sludge stored for 90 days

| | | Early | Late | |
|---|---|---|---|---|
| Aerobic granular | | apoptotic | apoptotic | |
| sludge | Living cells | cells | cells | Dead cells |
| Pilot system | 85.6 ± 3.5 | 8.4 ± 1.1 | 1.8 ± 0.2 | 4.2 ± 0.3 |
| Stored at −20° C. | 41.5 ± 1.8 | 6.0 ± 1.1 | 4.5 ± 1.0 | 48.0 ± 2.5 |
| Stored at 4° C. | 56.8 ± 2.2 | 18.2 ± 1.5 | 10.1 ± 1.2 | 15.1 ± 1.5 |
| Stored at 20° C. | 68.5 ± 2.9 | 14.1 ± 1.3 | 11.8 ± 1.2 | 5.6 ± 0.6 |

### Example 2: Verification of the Test Results of Aerobic Granular Sludge

Activity Recovery Conditions of the Stored Aerobic Granular Sludge:

The aerobic granular sludge derived from different serum bottles was inoculated into a sequencing batch reactor (SBR) for the activity recovery of aerobic granular sludge; the aerobic granular sludge stored at −20° C., 4° C. and 20° C. was placed in R1, R2 and R3, respectively. The SBR had an effective volume of 10.0 L, a water drainage ratio of 50%, a reaction period of 3 h, a static water inflow period of 60 min, an aeration reaction period of 112 min, a sludge settling period of 3 min, and a rapid drainage period of 5 min. The air and nitrogen content and proportion were controlled by a real-time control system to ensure the anaerobic state of the water inflow section and the aerobic state of the reaction section; and SRT was controlled to be 25 days.

Characteristics of Aerobic Granular Sludge after Activity Recovery:

After the activity recovery, all of the aerobic granular sludge in R1, R2 and R3 had good performance. As shown in Table 2, after recovering the aerobic granular sludge activity, the density and particle size of aerobic granular sludge at different preservation temperatures were close to those of aerobic granular sludge before preservation. Although the biomass of aerobic granular sludge (MLSS) at different preservation temperatures was only 91% of the biomass before preservation, on average, the biomass was 37.9% higher than the biomass of aerobic granular sludge after preservation, indicating that aerobic granular sludge re-adapted to the environment and the biomass was stably increased. Generally, the average denitrification rate and phosphorus release rate of activated sludge in the wastewater treatment plant were 3.0 mg/g MLSS·h and 2.2 mg/g MLSS·h, respectively. The domesticated aerobic granular sludge in the pilot plant will respectively take 25 d and 29 d to reach the same denitrification rate and phosphorus release rate. After the activity of the stored aerobic granular sludge was recovered, the aerobic granular sludge in R1 will respectively take 12 d and 13 d to reach the same denitrification rate and phosphorus release rate, the aerobic granular sludge in R2 will respectively take 10 d and 11 d to reach the same denitrification rate and phosphorus release rate, and the aerobic granular sludge in R3 will respectively take 8 d and 7 d to reach the same denitrification rate and phosphorus release rate, indicating that the aerobic granular sludge after the activity recovery all had better nitrogen and phosphorus removal effects, wherein the aerobic granular sludge stored at the temperature of 20° C. has the shortest activity recovery time and the condition at 20° C. was more suitable for storing the aerobic granular sludge.

TABLE 2
Properties of aerobic granular sludge after preservation and activity recovery

| | | | | | | Time (d) |
|---|---|---|---|---|---|---|
| | | | | | Time (d) | required for |
| | | | | | required for | phosphorus |
| | | Average | | | denitrification | release rate |
| | | particle | | | rate to be | to be more |
| | ρ | size | MLSS | MLVSS | more than 3.0 | than 2.2 mg/g |
| | (g/cm³) | (mm) | (mg/L) | (mg/L) | mg/g MLSS · h | MLSS · h |
| Before sludge | 1.025 | 1.6 | 8.7 | 7.7 | 25 | 29 |
| preservation | | | | | | |

After aerobic granular sludge preservation

| | | | | | | |
|---|---|---|---|---|---|---|
| After | 1.020 | 1.3 | 5.6 | 4.3 | — | — |
| preservation | | | | | | |
| at −20° C. | | | | | | |
| After | 1.018 | 1.2 | 5.8 | 4.7 | — | — |
| preservation | | | | | | |
| at 4° C. | | | | | | |
| After | 1.018 | 1.2 | 6.2 | 5.3 | — | — |
| preservation | | | | | | |
| at 20° C. | | | | | | |

After activity recovery of the aerobic granular sludge

| | | | | | | |
|---|---|---|---|---|---|---|
| Aerobic | 1.024 | 1.5 | 8.0 | 7.0 | 12 | 13 |
| granular | | | | | | |
| sludge stored | | | | | | |
| at −20° C. | | | | | | |
| Aerobic | 1.024 | 1.4 | 8.0 | 7.2 | 10 | 11 |
| granular | | | | | | |
| sludge stored | | | | | | |
| at 4° C. | | | | | | |
| Aerobic | 1.024 | 1.4 | 8.0 | 7.2 | 8 | 7 |
| granular | | | | | | |
| sludge stored | | | | | | |
| at 20° C. | | | | | | |

Settling Performance and Stability of Aerobic Granular Sludge after Activity Recovery:

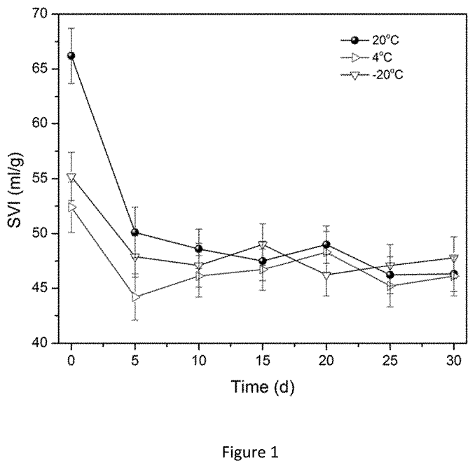

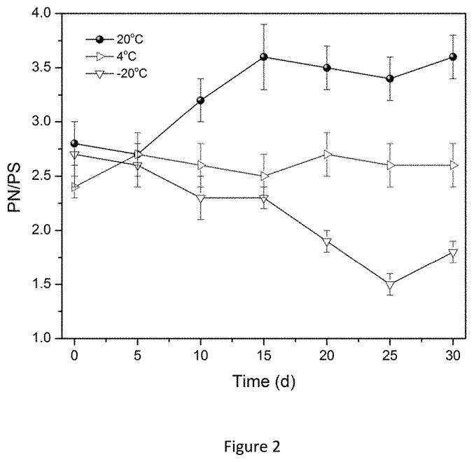

After the activity recovery, the aerobic granular sludge in R1, R2 and R3 had good settling performance, as shown in FIG. 1, and on the 10^{th} day of activity recovery, all of the aerobic granular sludge at different preservation temperatures had a volume index SVI of less than 50.0 mL/g. Subsequently, the SVI of aerobic granular sludge decreased slightly and eventually stabilized between 46.1 mL/g and 47.8 mL/g. Extracellular polymer was an important factor in the formation of aerobic granular sludge, and the ratio (PN/PS) of protein (PN) substance to polysaccharide (PS) substance in extracellular polymer was an important index for measuring the structural stability of the aerobic granular sludge. The changes in the extracellular polymer PN/PS during activity recovery process of the aerobic granular sludge were shown in FIG. 2. Under different preservation temperatures, PN/PS difference was large, and the PN/PS of the aerobic granular sludge in R1 was in a reduction trend, indicating that the aerobic granular sludge stored at −20° C. had a poor stability and the temperature was not suitable for storing the aerobic granular sludge; the PN/PS of the aerobic granular sludge in the R2 was slightly increased, indicating that the aerobic granular sludge stored at 4° C. can maintain the stable state before preservation; the PN/PS ratio of the aerobic granular sludge in the R3 was obviously increased and tended to be stable, indicating that the aerobic granular sludge stored at 20° C. had a gradually increased stability after recovering the activity, and the temperature was suitable for being used as the preservation temperature of the aerobic granular sludge.

Removal Efficiency of Pollutants by Aerobic Granular Sludge after Activity Recovery:

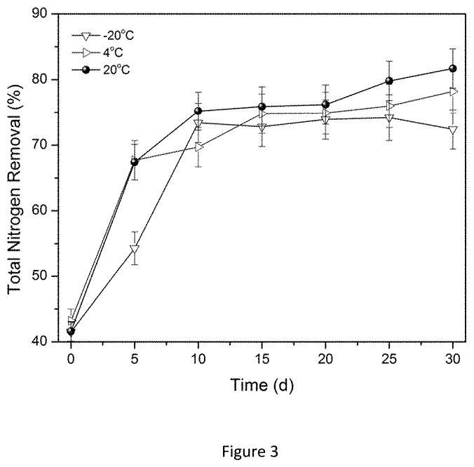

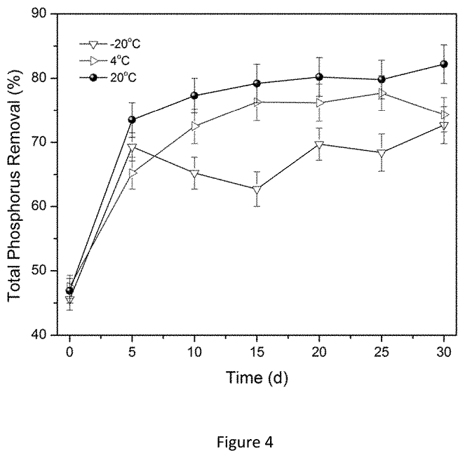

After the activity recovery process, the removal rates of total nitrogen and total phosphorus by aerobic granular sludge at different preservation temperatures were gradually increased (FIG. 3 and FIG. 4), and the removal rates of total nitrogen (TN) and total phosphorus (TP) were over 70%. On the 10th day after the activity recovery, the aerobic granular sludge in R3 had the best removal effect on TN and TP, and the TN and TP removal rates showed a steady increase trend. This result also corresponded to the fastest recovery of the higher denitrification rate and phosphorus release rate by the aerobic granular sludge in R3 in Table 2, indicating that the condition at 20° C. was more suitable for storing aerobic granular sludge and was highly feasible in practical applications.

Correlation Between Aerobic Granular Sludge Characteristics and Sludge Cell States after Activity Recovery:

After 30 d of aerobic granular sludge activity recovery, flow cytometry was used to analyze the aerobic granular sludge cell states (as shown in Table 3). The living cell content in aerobic granular sludge at different preservation temperatures was basically the same as the content of living cells in the aerobic granular sludge of the pilot system, indicating that all of the aerobic granular sludge after the activity recovery can play the role of pollutant removal. Among them, the proportion of aerobic granular sludge living cells in R3 was the highest (86.5%±3.5%), and the proportion of late apoptotic cells (3.8%±1.0%) and the proportion of dead cells (3.3%±0.3%) were the lowest, indicating the aerobic granular sludge cells stored at 20° C. had the highest cell activity and 20° C. was more suitable as a condition for storing aerobic granular sludge.

TABLE 3
Cell activity states (%) of aerobic granular
sludge cells after activity recovery (30 d)

| | | Early | Late | |
|---|---|---|---|---|
| Aerobic granular | | apoptotic | apoptotic | |
| sludge | Living cells | cells | cells | Dead cells |
| Pilot system | 86.5 ± 3.9 | 6.7 ± 1.4 | 5.8 ± 0.8 | 1.0 ± 0.2 |
| Stored at −20° C. | 82.3 ± 3.8 | 6.5 ± 1.5 | 6.2 ± 1.3 | 5.0 ± 0.2 |
| Stored at 4° C. | 83.1 ± 3.2 | 6.5 ± 1.3 | 6.3 ± 1.2 | 4.1 ± 0.3 |
| Stored at 20° C. | 86.5 ± 3.5 | 6.4 ± 1.3 | 3.8 ± 1.0 | 3.3 ± 0.3 |

According to Correl correlation analysis, it was found that the denitrification rate and the phosphorus release rate of aerobic granular sludge had a very high correlation with the proportion of aerobic granular sludge live cells (as shown in Table 4), and the correlation coefficients were 0.9940 and 0.9954, respectively, indicating that the use of the proportion of aerobic granular sludge living cells as a method for evaluating the activity of aerobic granular sludge was extremely feasible. At the same time, in the stored aerobic granular sludge, the proportion of aerobic granular sludge live cells was the highest under the preservation condition of 20° C., which was consistent with results for the proportion of aerobic granular sludge living cells in R3 after activity recovery.

TABLE 4
Correlation between aerobic granular sludge characteristics
and cell activity sates after activity recovery

| | Aerobic | Aerobic | Aerobic |
|---|---|---|---|
| | granular | granular | granular |
| | sludge stored | sludge stored | sludge stored |
| | at −20° C. | at 4° C. | at 20° C. |
| Denitrification rate (mg/g | 3.18 | 3.23 | 3.35 |
| MLSS · h) | | | |
| Phosphorus release rate | 2.36 | 2.45 | 2.68 |
| (mg/g MLSS · h) | | | |
| Living cell proportion (%) | 82.3 ± 3.8 | 83.1 ± 3.2 | 86.5 ± 3.9 |

| | |
|---|---|
| Correlation between | 0.9940 |
| denitrification rate and | |
| living cells | |
| Correlation between | 0.9954 |
| phosphorus release with | |
| living cells | |

Therefore, it was determined that 20° C. was the most suitable condition for storing aerobic granular sludge, and flow cytometry can be used as the basis for determining the optimum preservation temperature of aerobic granular sludge. Flow cytometry is easy to operate, the data are fast and easy to obtain, accurate and reliable, and the aerobic granular sludge activity recovery process can be omitted, which is of great significance for the preservation and activity recovery of aerobic granular sludge.

### Example 3: Determination of the Optimum Preservation Temperature of Nitrifying-Denitrifying Biofilm

Preservation and Culture of Nitrifying-Denitrifying Biofilm:

The preservation temperature of the nitrifying-denitrifying biofilm was set to −20° C., 4° C. and 20° C. 180 nitrifying-denitrifying biofilms in the biochemical reaction tank of the wastewater treatment plant were taken out, divided into three equal portions and placed in 1000 mL serum bottles containing 500 mL of preservation medium to maintain the nitrification and denitrification capacity of the biofilm, respectively. The components of preservation medium were as follows: NaAc of 240 mg/L, NH₄Cl of 110 mg/L, KNO₃ of 80 mg/L, K₂HPO₄ of 30 mg/L, KH₂PO₄ of 15 mg/L, MgSO₄ of 40 mg/L, and KCl of 70 mg/L. The preservation medium had a COD of 200 mg/L, NH₄⁺—N of 30 mg/L, NO₃⁻—N of 20 mg/L, and PO₄³⁻—P of 8 mg/L. Serum bottles (3 parallel samples at each preservation temperature) were placed at −20° C., 4° C. and 20° C., and stored statically in the dark.

Cell State Test of Stored Nitrifying-Denitrifying Biofilm:

The nitrifying-denitrifying biofilms stored at −20° C., 4° C. and 20° C. for more than 120 d were used to determine the cell state of nitrifying-denitrifying biofilms. The cell state test conditions of flow cytometry were as follows:

(1) 10 mL nitrifying-denitrifying biofilm was taken, diluted to 100 mL with phosphate buffer of pH 7.0, and shaken for 2 min in a vortexer to break the biofilm into flocs and ensure a uniform distribution;

(2) The crushed sample was filtered through a nylon membrane having a pore size of 6 μm, and 1.5 mL was placed in a 1.5 mL sharp-bottomed centrifuge tube;

(3) The sample was centrifuged at 8000 rpm for 5 min;

(4) The supernatant of the sample after centrifugation was pipetted with leaving about 0.1 mL of sample, the cells were purged with pre-cooled phosphate buffer, and the centrifugation and wash were repeated twice;

(5) The supernatant of the sample after centrifugation was pipetted with leaving about 0.1 mL of sample, and mixed well with 0.3 mL of 10× Annexin V Binding Buffer;

(6) 0.5 μl of PI staining agent was added to the control FITC Annexin V group, 0.5 μL of FITC Annexin V was added to the control PI group, 0.5 μL of FITC Annexin V and 0.5 μL of PI were added to the test group, which were mixed well and incubated for 15 min at room temperature in the dark, and then tested on a flow cytometer.

The selection of the filtration pore size in the preparation of the sample was particularly important. If the pore size was too large, more biological flocs will be introduced, uneven dyeing will be produced, which will affect the final result; if the pore size was too small, the biological flocs cannot be effectively obtained.

The cell state results of nitrifying-denitrifying biofilm were shown in Table 5. The living cells proportion of nitrifying-denitrifying biofilm in the biochemical reaction tank of the wastewater treatment plant was higher, indicating that the wastewater treatment plant works well. The nitrifying-denitrifying biofilm stored at −20° C. had the lowest living cell content and the highest dead cell content, indicating that it was not suitable to store nitrifying-denitrifying biofilm at −20° C. The nitrifying-denitrifying biofilm stored at 4° C. had the highest living cell proportion of 68.0% and a proportion of late apoptotic cells and dead cells of about 19.8%, indicating that the 4° C. condition can be used for the preservation of nitrifying-denitrifying biofilm. When the preservation temperature was 20° C., the living cell proportion of nitrifying-denitrifying biofilm was as high as 59.4%, which was only 12.6% lower than that of the nitrifying-denitrifying biofilm stored at 4° C., but the proportion of late apoptotic cells and dead cells for such nitrifying-denitrifying biofilm was about 31.6%, indicating that the preservation condition at 20° C. was not suitable for storing nitrifying-denitrifying biofilm, either. Therefore, it was preliminarily determined that 4° C. was the optimum temperature for storing nitrifying-denitrifying biofilm.

TABLE 5
Cell activity states (%) of nitrifying-
denitrifying biofilm stored for 120 days

| Nitrifying- | | Early | late | |
|---|---|---|---|---|
| denitrifying | | apoptotic | apoptotic | |
| biofilm | Living cells | cells | cells | Dead cells |
| Biochemical | 85.0 ± 3.2 | 9.7 ± 1.0 | 4.5 ± 0.2 | 0.8 ± 0.2 |
| reaction tank | | | | |
| Stored at −20° C. | 40.7 ± 2.0 | 24.6 ± 1.8 | 23.4 ± 1.5 | 11.3 ± 1.5 |
| Stored at 4° C. | 68.0 ± 2.9 | 12.2 ± 1.2 | 12.4 ± 0.9 | 7.4 ± 1.2 |
| Stored at 20° C. | 59.4 ± 2.5 | 13.9 ± 1.1 | 17.7 ± 1.0 | 9.0 ± 1.6 |

### Example 4: Verification of the Test Results of Nitrifying-Denitrifying Biofilm

Activity Recovery Conditions of the Stored Nitrifying-Denitrifying Biofilm:

The operation mode of sequencing batch reactor was used: nitrifying-denitrifying biofilm derived from different serum bottles was inoculated into a bioreactor (effective volume 10.0 L) for the activity recovery of nitrifying-denitrifying biofilm. The nitrifying-denitrifying biofilm stored at −20° C., 4° C. and 20° C. were placed in R1, R2 and R3, respectively. Based on the anoxic-oxic (AO) process, the bioreactor achieved simultaneous nitrification and denitrification in the sequencing batch reaction. The HRT was set to 12 h, the nitrification and denitrification filling ratio was 50%, and the nitrification liquid reflux ratio was 80%.

Characteristics of Nitrifying-Denitrifying Biofilm after Activity Recovery:

After the activity recovery, all of the nitrifying-denitrifying biofilm in R1, R2 and R3 had good performance. As shown in Table 6, after recovering the nitrifying-denitrifying biofilm activity, the density and thickness of nitrifying-denitrifying biofilm stored at 4° C. and 20° C. were close to those of nitrifying-denitrifying biofilm before preservation, and only the density and thickness of nitrifying-denitrifying biofilm stored at −20° C. slightly decreased. The biomass of nitrifying-denitrifying biofilm at different preservation temperatures all decreased, but after activity recovery, the biomass of nitrifying-denitrifying biofilm stored at 4° C. and 20° C. has achieved the biomass level of nitrifying-denitrifying biofilm before preservation, indicating that nitrifying-denitrifying biofilm re-adapted to the environment and the biomass was stably increased. Generally, the average nitrification rate and denitrification rate of biofilm in the wastewater treatment were 4.5 g NO₃⁻—N/m²·d and 5.0 g NO₃⁻-N/m²·d, respectively. The domesticated nitrifying-denitrifying biofilm in the wastewater treatment plant will respectively take 25 d and 21 d to reach the same nitrification rate and denitrification rate. After the activity of the stored nitrifying-denitrifying biofilm was recovered, the nitrifying-denitrifying biofilm in R1 will respectively take 19 d and 17 d to reach the same nitrification rate and denitrification rate, the nitrifying-denitrifying biofilm in R2 will respectively take 8 d and 6 d to reach the same nitrification rate and denitrification rate, and the nitrifying-denitrifying biofilm in R3 will respectively take 13 d and 10 d to reach the same nitrification rate and denitrification rate. The biofilm thickness L of R1 was significantly reduced before and after the activity recovery, but a higher thickness can be maintained in both R2 and R3, so that a concentration gradient of oxygen was produced in the biofilm, which was beneficial to denitrification. It is indicated that all of the nitrifying-denitrifying biofilms after activity recovery had good denitrification effect. The nitrifying-denitrifying biofilm stored at 4° C. had the shortest activity recovery time and the condition at 4° C. was suitable for storing nitrifying-denitrifying biofilm.

TABLE 6
Properties of nitrifying-denitrifying biofilm after preservation and activity recovery

| | | | | | Time | Time |
|---|---|---|---|---|---|---|
| | | | | | required for | required for |
| | | | | | nitrification | denitrification |
| | | | | | rate to be | rate to be |
| | | | | | more than | more than |
| | | | | | 4.5 g NO₃⁻—N/ | 5.0 g NO₃⁻—N/ |
| | ρ | L | MLSS | MLVSS | m² · d | m² · d |
| | (g/cm³) | (μm) | (mg/L) | (mg/L) | (d) | (d) |
| Biochemical | 0.031 | 202 | 12.9 | 6.3 | 25 | 21 |
| reaction | | | | | | |
| tank | | | | | | |

After the preservation of nitrifying-denitrifying biofilm

| | | | | | | |
|---|---|---|---|---|---|---|
| After | 0.029 | 171 | 11.1 | 5.0 | — | — |
| preservation | | | | | | |
| at −20° C. | | | | | | |
| After | 0.030 | 201 | 12.6 | 6.0 | — | — |
| preservation | | | | | | |
| at 4° C. | | | | | | |
| After | 0.029 | 200 | 12.3 | 5.8 | — | — |
| preservation | | | | | | |
| at 20° C. | | | | | | |

After the activity recovery of nitrifying-denitrifying biofilm

| | | | | | | |
|---|---|---|---|---|---|---|
| Nitrifying- | 0.028 | 189 | 12.0 | 5.3 | 19 | 17 |
| denitrifying | | | | | | |
| biofilm stored | | | | | | |
| at −20° C. | | | | | | |
| Nitrifying- | 0.030 | 205 | 12.4 | 6.2 | 8 | 6 |
| denitrifying | | | | | | |
| biofilm stored | | | | | | |
| at 4° C. | | | | | | |
| Nitrifying- | 0.029 | 207 | 12.5 | 6.0 | 13 | 10 |
| denitrifying | | | | | | |
| biofilm stored | | | | | | |
| at 20° C. | | | | | | |

Stability of Nitrifying-Denitrifying Biofilm after Activity Recovery:

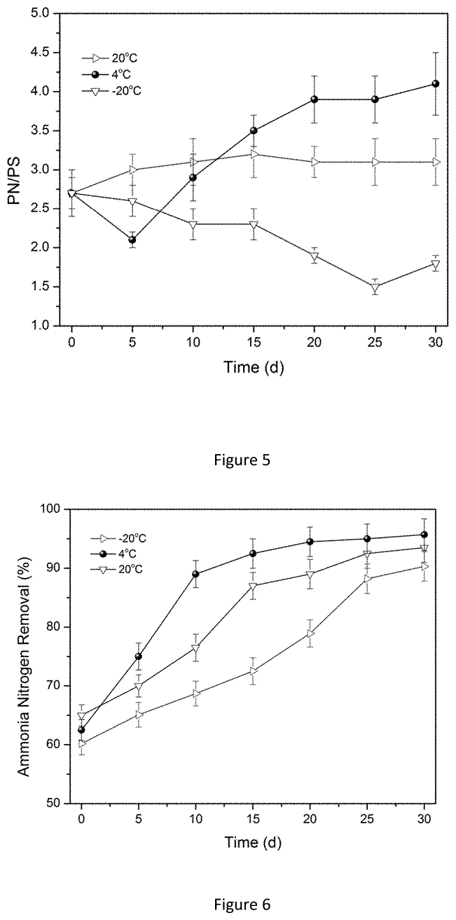

Extracellular polymer was an important factor in the formation of nitrifying-denitrifying biofilm, and the ratio (PN/PS) of protein (PN) substance to polysaccharide (PS) substance in extracellular polymer was an important index for measuring the structural stability of the nitrifying-denitrifying biofilm. The changes in the extracellular polymer PN/PS during activity recovery process of the nitrifying-denitrifying biofilm were shown in FIG. 5. Under different preservation temperatures, PN/PS difference was large, and the PN/PS of the nitrifying-denitrifying biofilm in R1 was in a reduction trend, indicating that the nitrifying-denitrifying biofilm stored at −20° C. had a poor stability and the temperature was not suitable for storing the nitrifying-denitrifying biofilm; the PN/PS of the nitrifying-denitrifying biofilm in the R3 was slightly increased, indicating that the nitrifying-denitrifying biofilm stored at 20° C. can maintain the stable state before preservation; the PN/PS ratio of the nitrifying-denitrifying biofilm in the R2 was obviously increased up to 4.2 or more and tended to be steady, indicating that the nitrifying-denitrifying biofilm stored at 4° C. had a gradually increased stability after recovering the activity, and the condition at 4° C. was suitable for being used as the preservation temperature of the nitrifying-denitrifying biofilm.

Removal Efficiency of Pollutants by Nitrifying-Denitrifying Biofilm after Activity Recovery:

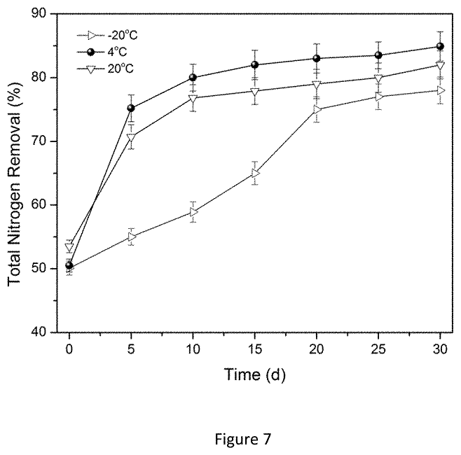

After the activity recovery process, the removal rates of ammonia nitrogen and total nitrogen by nitrifying-denitrifying biofilm at different preservation temperatures were gradually increased (FIG. 6 and FIG. 7), and the removal rates of ammonia nitrogen and total nitrogen were over 90% and 80%, respectively. On the 8^{th} day after the activity recovery, the nitrifying-denitrifying biofilm in R2 had the best removal effects on ammonia nitrogen and total nitrogen, and the ammonia nitrogen and total nitrogen removal rates showed a steady increase trend. This result also corresponded to the fastest recovery of the higher nitrification rate and denitrification rate by the nitrifying-denitrifying biofilm in R2 in Table 6, indicating that the condition at 4° C. was more suitable for storing nitrifying-denitrifying biofilm and was highly feasible in practical applications.

Correlation Between Nitrifying-Denitrifying Biofilm Characteristics and Sludge Cell States after Activity Recovery:

After the nitrifying-denitrifying biofilm activity recovery, flow cytometry was used to analyze the nitrifying-denitrifying biofilm cell states as shown in Table 7. The living cell content in nitrifying-denitrifying biofilm at different preservation temperatures was basically the same as the content of living cells in the nitrifying-denitrifying biofilm of the wastewater treatment plant, indicating that all of the nitrifying-denitrifying biofilm after the activity recovery can play the role of pollutant removal. Among them, the proportion of nitrifying-denitrifying biofilm living cells in R2 was the highest (84.3%±3.0%), and the proportion of late apoptotic cells (6.2%±1.5%) and the proportion of dead cells (4.3%±0.3%) were the lowest, indicating the nitrifying-denitrifying biofilm cells stored at 4° C. had the highest cell activity and 4° C. was more suitable as a condition for storing nitrifying-denitrifying biofilm.

TABLE 7
Cell activity states (%) of nitrifying-denitrifying
biofilm after activity recovery

| Nitrifying- | | Early | Late | |
|---|---|---|---|---|
| denitrifying | | apoptotic | apoptotic | |
| biofilm | Living cells | cells | cells | Dead cells |
| Biochemical | 85.1 ± 3.0 | 8.9 ± 0.7 | 5.0 ± 0.2 | 1.0 ± 0.1 |
| reaction tank | | | | |
| Stored at −20° C. | 82.5 ± 3.5 | 6.5 ± 1.8 | 6.5 ± 1.3 | 4.5 ± 0.5 |
| Stored at 4° C. | 84.0 ± 3.0 | 5.5 ± 1.7 | 6.2 ± 1.5 | 4.3 ± 0.3 |
| Stored at 20° C. | 83.0 ± 3.1 | 5.8 ± 1.7 | 6.8 ± 1.3 | 4.4 ± 0.7 |

According to Correl correlation analysis, as shown in table 8, the nitrification rate and the denitrification rate of nitrifying-denitrifying biofilm had a very high correlation with the proportion of nitrifying-denitrifying biofilm live cells, and the correlation coefficients were 0.9286 and 0.9819, respectively, indicating that the use of the proportion of nitrifying-denitrifying biofilm living cells as a method for evaluating the activity of nitrifying-denitrifying biofilm was extremely feasible. At the same time, in the stored nitrifying-denitrifying biofilm, the proportion of nitrifying-denitrifying biofilm live cells was the highest under the preservation condition of 4° C., which was consistent with results for the proportion of nitrifying-denitrifying biofilm living cells in R2 after activity recovery.

TABLE 8
Correlation between nitrifying-denitrifying biofilm characteristics
and cell activity sates after activity recovery

| | Nitrifying- | Nitrifying- | Nitrifying- |
|---|---|---|---|
| | denitrifying biofilm | denitrifying biofilm | denitrifying biofilm |
| | stored at −20° C. | stored at 4° C. | stored at 20° C. |
| Nitrification rate (g | 4.7 | 5.0 | 4.9 |
| NO3⁻-N/m² · d) | | | |
| Denitrification rate (g | 5.1 | 5.5 | 5.3 |
| NO3⁻-N/m² · d) | | | |
| Living cells proportion | 82.5 ± 3.5 | 84.0 ± 3.0 | 83.0 ± 3.1 |
| (%) | | | |

| | |
|---|---|
| Correlation between | 0.9286 |
| nitrification rate and | |
| living cells | |
| Correlation between | 0.9820 |
| denitrification rate | |
| and living cells | |

Therefore, it was determined that 4° C. was the most suitable condition for storing nitrifying-denitrifying biofilm, and flow cytometry can be used as the basis for determining the optimum preservation temperature of nitrifying-denitrifying biofilm. Flow cytometry is easy to operate, the data are fast and easy to obtain, accurate and reliable, and the nitrifying-denitrifying biofilm activity recovery process can be omitted, which is of great significance for the preservation and activity recovery of nitrifying-denitrifying biofilm.

### Example 5: Test for Optimum Preservation Temperature of Nitrifying-Denitrifying Biofilm in Different pH Environments

Preservation and Culture of Nitrifying-Denitrifying Biofilm:

The preservation temperature of the nitrifying-denitrifying biofilm was set to −20° C., 4° C. and 20° C. 180 nitrifying-denitrifying biofilms in the biochemical reaction tank of the wastewater treatment plant were taken out, divided into three equal portions and placed in 1000 mL serum bottles containing 500 mL of preservation medium, respectively. The components of preservation medium were as follows: NaAc of 240 mg/L, NH₄Cl of 110 mg/L, KNO₃ of 80 mg/L, K₂HPO₄ of 30 mg/L, KH₂PO₄ of 15 mg/L, MgSO₄ of 40 mg/L, and KCl of 70 mg/L. The preservation medium had a COD of 200 mg/L, NH₄⁺—N of 30 mg/L, NO₃—N of 20 mg/L, and PO₄³⁻—P of 8 mg/L. Serum bottles (3 parallel samples at each preservation temperature) were placed at −20° C., 4° C. and 20° C., and stored statically in the dark.

Cell State Test of Stored Nitrifying-Denitrifying Biofilm:

The nitrifying-denitrifying biofilms stored at −20° C., 4° C. and 20° C. for more than 120 d were used to determine the cell state of nitrifying-denitrifying biofilms. The cell state test conditions of flow cytometry were as follows:

(1) 10 mL nitrifying-denitrifying biofilm was taken, diluted to 100 mL with phosphate buffer of pH 7.2, and shaken for 2 min in a vortexer to break the biofilm into flocs and ensure a uniform distribution;

(2) The crushed sample was filtered through a nylon membrane having a pore size of 6 μm, and 1.5 mL was placed in a 1.5 mL sharp-bottomed centrifuge tube;

(3) The sample was centrifuged at 8000 rpm for 5 min;

(4) The supernatant of the sample after centrifugation was pipetted with leaving about 0.1 mL of sample, the cells were purged with pre-cooled phosphate buffer, and the centrifugation and wash were repeated twice;

(5) The supernatant of the sample after centrifugation was pipetted with leaving about 0.1 mL of sample, and mixed well with 0.3 mL of 10× Annexin V Binding Buffer;

(6) 0.5 μL of PI staining agent was added to the control FITC Annexin V group, 0.5 μL of FITC Annexin V was added to the control PI group, 0.5 μL of FITC Annexin V and 0.5 μL of PI were added to the test group, which were mixed well and incubated for 15 min at room temperature in the dark, and then tested on a flow cytometer.

The test results for cell state of nitrifying-denitrifying biofilm were shown in table 9.

TABLE 9
Cell activity states (pH 7.2) of nitrifying-
denitrifying biofilm stored for 120 days

| Nitrifying- | | Early | Late | |
|---|---|---|---|---|
| denitrifying | | apoptotic | apoptotic | |
| biofilm | Living cells | cells | cells | Dead cells |
| Stored at −20° C. | 47.0 ± 2.0 | 14.6 ± 1.5 | 22.5 ± 1.9 | 15.9 ± 1.7 |
| Stored at 4° C. | 48.0 ± 2.4 | 15.1 ± 1.1 | 23.5 ± 2.0 | 13.4 ± 1.8 |
| Stored at 20° C. | 49.1 ± 2.1 | 14.9 ± 1.1 | 21.7 ± 2.1 | 14.3 ± 1.1 |

From the results of Table 9, it was found that the samples prepared by using the phosphate buffer of pH 7.2 were selected to be tested, the proportion of the cell state in the living condition at each preservation temperature was relatively close, the beneficial results could not be obtained for analysis, and the data reliability was poor.

In addition, the inventors also investigated the effect of filter pore size on the sample test: the nitrifying-denitrifying biofilm samples were respectively prepared with pore sizes of 8 μm and 10 μm, and it was found that the analysis results of the sample prepared with pore size of 8 μm were consistent with the verification experiment, and the data was reliable; the corresponding data with 10 μm did not have analytical capacity and cannot be used to determine the optimum preservation temperature.

What is claimed is:

1. A method for determining an optimum preservation temperature of a wastewater treatment biofilm, comprising: measuring a cell activity state of the wastewater treatment biofilm based on flow cytometry; comparing the measured results of the cell activity states of the biofilm preserved at different temperatures with those of the biofilm before preservation; and taking the preservation temperature closest to the cell activity state of the biofilm before preservation as the optimum preservation temperature, wherein the measuring the cell activity state comprises measuring the content of living cells, early apoptotic cells, late apoptotic cells and dead cells.

2. The method according to claim 1, wherein the wastewater treatment biofilm comprises aerobic granular sludge and a nitrifying-denitrifying biofilm.

3. The method according to claim 1, wherein the measuring the cell activity state of the wastewater treatment biofilm based on the flow cytometry comprises:
(1) preparing a test sample solution of the wastewater treatment biofilm: diluting a biofilm sample with a buffer, shaking evenly, filtering, centrifuging, leaving a supernatant, purging the cells with a pre-cooled phosphate buffer, repeating centrifugation and wash twice, then taking the supernatant as a sample, and mixing well with an appropriate amount of 10× Annexin V Binding Buffer; and
(2) placing in a flow cytometer for measuring the cell activity state of each sample solution.

4. The method according to claim 3, wherein a nylon membrane having a pore size of 5-15 μm is used for filtration when the biofilm is aerobic granular sludge.

5. The method according to claim 3, wherein a nylon membrane having a pore size of 6-8 μm is used for filtration when the biofilm is a nitrifying-denitrifying biofilm.

6. The method according to claim 3, wherein when the biofilm is aerobic granular sludge, the test sample solution is prepared by diluting the aerobic granular sludge with a buffer of pH 7.0-8.0.

7. The method according to claim 3, wherein when the biofilm is a nitrifying-denitrifying biofilm, the test sample solution is prepared by diluting the nitrifying-denitrifying biofilm with a buffer of pH 6.6-7.0.

8. The method according to claim 3, wherein a dilution volume ratio of the buffer to the biofilm is 8-10:1.

9. A method for rapidly initiating biofilm engineering, comprising: using the method according to claim 1 to determine an optimum preservation temperature of a biofilm; preliminarily culturing and maturing the biofilm; placing in a preservation medium and preserving at the optimum preservation temperature; recovering activity; and using for an engineering application.

10. The method according to claim 9, wherein when the biofilm is aerobic granular sludge, the preservation medium has a COD of 250 to 350 mg/L, NH₄⁺—N of 55-65 mg/L, and PO₄³⁻—P of 6-10 mg/L.

11. The method according to claim 9, wherein when the biofilm is aerobic granular sludge, the recovering the activity comprises inoculating the aerobic granular sludge into a sequencing batch reactor with a water drainage ratio of 45-60%, a reaction period of 2.5-4 h, a static water inflow period of 1-1.5 h, an aeration reaction period of 1.5-2.5 h, a sludge settling period of 2-6 min, and a rapid drainage period of 2-6 min.

12. The method according to claim 11, wherein the sequencing batch reactor controls air and nitrogen content and proportion to ensure an anaerobic state of a water inflow section and an aerobic state of a reaction section by a real-time control system.

13. The method according to claim 9, wherein when the biofilm is a nitrifying-denitrifying biofilm, the preservation medium has a COD of 180-220 mg/L, NH₄⁺—N of 25-35 mg/L, NO₃⁻—N of 18-25 mg/L and PO₄³⁻—P of 6-10 mg/L.

14. The method according to claim 9, wherein when the biofilm is a nitrifying-denitrifying biofilm, the recovering the activity comprises inoculating the nitrifying-denitrifying biofilm into a bioreactor on the basis of an anoxic-oxic process with a setting time of 10-15 h, a nitrifying-denitrifying biofilm filling ratio of 40%-60%, and a nitrifying liquid reflux ratio of 70%-85%.
